(19) United States
(12) Patent Application Publication
(10) Pub. No.: US 2026/0240216 A1
(43) Pub. Date: Aug. 20, 2026

(54) Yeast Oleosome Composition

(71) Applicant: CULTIVATED BIOSCIENCES SA, Saint-Aubin (CH)

(72) Inventors: Dimitri ZOGG, Zurich (CH); Eugenio SPADONI ANDREANI, Adliswil (CH); Georgios AGORASTOS, Zurich (CH); Tomas TURNER, Wadenswil (CH)

(21) Appl. No.: 19/164,664

(22) PCT Filed: Mar. 15, 2024
(86) PCT No.: PCT/EP2024/056975

§ 371 Date: Sep. 12, 2025

(30) Foreign Application Priority Data
Mar. 15, 2023 (EP) 23162197.0
Mar. 16, 2023 (EP) 23162403.2
Aug. 16, 2023 (EP) 23191790.7

(51) Int. Cl. A23L 33/145

(52) U.S. Cl. CPC A23L 33/145

(57) ABSTRACT

The present invention relates to a yeast oleosome composition comprising yeast oleosomes and at least one isolated yeast cell wall component and preferably having specific particle size, density and zeta potential. The composition is characterized by good physical stability and sensory properties. The invention also relates to a process for producing a yeast oleosome composition of the invention, to products comprising the yeast oleosome composition of the invention and to the use of the composition for improving the sensory properties of a food composition or beverage or of an edible ingredient. Furthermore, the composition of the present invention has proven useful in reducing the intensity of astringency in food products and beverages.

### TECHNICAL FIELD

The present invention relates to a yeast oleosome composition comprising yeast oleosomes and at least one isolated yeast cell wall component and preferably having specific particle size, density and zeta potential. The composition is characterized by good physical stability and sensory properties. The invention also relates to a process for producing a yeast oleosome composition of the invention, to products comprising the yeast oleosome composition of the invention and to the use of the composition for improving the sensory properties of a food composition or beverage or of an edible ingredient. Furthermore, the composition of the present invention has proven useful in reducing the intensity of astringency in food products and beverages.

### BACKGROUND ART

Various types of dairy alternatives are developing as the vegetarian and vegan diets are getting more and more frequent. Most dairy alternatives are plant-based and are for example based on oil bodies or oleosomes. Most of the prior art relates to compositions based on plant oleosomes.

Oleosomes, also commonly named lipid droplets or oil bodies are stable oil bodies having a core of triglycerides surrounded by a membrane composed of phospholipids and proteins. Oleosomes are present in large amounts in plants, particularly in seeds and are also known to be found in other organisms, such as yeast and other microbes. The composition of oleosomes and their properties vary from one source to another.

For example, Nikiforidis et al., RSC Adv., 2014, 4, 25067 discloses natural emulsions based on oil bodies from plants, which have properties close to dairy milk or cream. Oil bodies are extracted from plant materials by using aqueous media. An oil-in-water emulsion, based on intact or partially disrupted oil bodies is obtained and a protein co-extraction takes place. The oil bodies size can be nanometric, up to a few microns.

WO98/53698A1 discloses emulsion formulations prepared from oil bodies originating from living cells. The content of the document is focused on plant oil bodies, but other sources of oil bodies are mentioned in a very general way, including fungal sources, such as yeast cells. The oil bodies are obtained from a cell, washed and formulated. All disclosed process aspects are focusing on the preparation of formulations from plant seeds. The size of the oil bodies varies between 0.4 and 1.5 μm. The disclosed emulsions can be used as substitutes for dairy products.

WO2017/066569A1 discloses oleosome compositions comprising two different oleosome compositions, preferably originating from two different sources, and having different particles sizes: a first oleosome composition is characterized by a D50 of at least 120 nm and the second oleosome composition is characterized by a D50 of at least 600 nm. Yeast cells are mentioned in very general terms. However, all aspects described in detail are related to plant oleosomes.

WO2021126409A1 discloses roasted oleosome compositions, which may originate from a variety of sources, including yeast, but preferably originating from plant sources. The isolated oleosome composition has a dry-matter content of 30 to 80 wt %, and, based on dry matter, a protein content of 1 to 6% and an oil content of 94 to 99%.

Despite extensive research to develop alternatives to dairy products, there is a need to further improve the mouthfeel of non-dairy products. Indeed, consumers still perceive a difference in mouthfeel and mouthcoating between dairy products and their non-dairy alternatives to milk and cream. In order to further stimulate the consumption of these more environmentally friendly alternatives, it would be desirable to improve the consumer acceptance of non-dairy products. There is therefore a need to further fine-tune oleosome composition in order to improve the physical and sensory properties in view of producing dairy substitute applications that are closer to the expectations of consumers in terms of creaminess and mouthfeel.

Furthermore, the production of plants requires large surfaces of land and consumes substantial amounts of water, which tends more and more to become a scarce resource. It would therefore be desirable to provide a reliable and fine-tuned alternative to dairy products which does not originate from plants.

The present invention aims at solving these problems.

### SUMMARY OF INVENTION

In a first aspect, the invention provides a yeast oleosome composition comprising yeast oleosomes and at least one yeast cell wall component selected from chitin, β-D-glucan and mannoprotein, wherein such yeast cell wall component is released from the cell wall structure.

In a particular aspect the yeast oleosome composition is in the form of a yeast oleosome-based dairy alternative.

In a second aspect, the present invention relates to a process for the production of the yeast oleosome composition according to the invention comprising the steps of
a) providing oleaginous yeast cells
b) lysing the cell wall; and
c) separating the oleosomes from the other yeast cell components.

In a third aspect, the present invention relates to a product obtained or obtainable by the process of the invention.

In a fourth aspect, the present invention relates to a food product, a beverage, a feed product or a cosmetic composition comprising the yeast oleosome composition according to the present invention.

In a fifth aspect, the present invention relates to the use of the yeast oleosome composition of the invention for improving the sensory properties and/or the physical stability of a food product or beverage or of an edible ingredient.

In a sixth aspect, the present invention relates to a lyophilizate of a yeast oleosome composition according to the invention (i.e. a yeast oleosome composition in solid form).

In a seventh aspect, the present invention relates to a yeast oleosome composition characterized by a mean diameter by volume of 0.2 to 7 μm as measured by laser diffraction, a density of 0.8 to 1.1 g/ml, a pH of 5-8 and a zeta potential of −40 to −5 mV at physiological pH, preferably wherein the particle size, the density, the pH and the zeta potential, total solids content, fat content, saturated fat content, carbohydrate content, protein content, yeast definition and friction coefficient are as disclosed in any preferred embodiments of the detailed description below.

In an eighth aspect, the invention relates to the use of a yeast oleosome composition of the invention for the reduction of the intensity of astringency of a food product, of a beverage or of an edible ingredient.

In a ninth aspect, the invention relates to the use of a yeast oleosome composition of the invention for reducing the perception of astringency by a subject upon consumption of a food product, of a beverage or of an edible ingredient.

In a tenth aspect, the invention relates to a food product or beverage comprising a yeast oleosome composition of the invention and at least one astringent component.

### BRIEF DESCRIPTION OF DRAWINGS

FIG. 1 Results of the comparative stability test of samples A1 and A2 according to the invention and comparative coconut, oat, almond, cashew and soy oleosome milks, as assessed in Example 6.

FIG. 2 Friction measurement as a function of sliding velocity of samples A1 and A2 according to the invention and comparative coconut, oat, almond, cashew and soy oleosome milks, as assessed in Example 6.

FIG. 3 Viscosity measurements as function of shear rate of an oleosome composition suitable as an alternative to dairy cream of the invention and comparative plant-based creams (Cultivated sample), as assessed in Example 7.

FIG. 4 Viscosity measurements as function of shear rate with commercial products (dairy and plant based) and an oleosome composition suitable as an alternative to dairy cream of the invention (Cultivated Cream sample), as assessed in Example 8.

FIG. 5 Friction measurement as a function of sliding velocity of a composition of the invention suitable as an alternative to dairy cream (Cultivated cream 20%) and commercial plant-based creams (Vlove cream, Soja cuisine and Oat cuisine), as assessed in Example 9.

FIG. 6 Results of the soft tribology measurements performed in Example 10 representing delta friction coefficient (Au) for a sample comprising a pea protein solution in saliva, a sample wherein the pea protein solution is combined with a yeast oleosome composition of the invention and saliva, a sample comprising only the yeast oleosome of the invention in saliva and a control consisting of water in saliva.

FIG. 7 Graph representing the definition of delta friction coefficient (Δμ): a schematic representation of the friction coefficient, μ, as a function of time obtained by the dynamic protocol as used in Example 10. Saliva is added at time 0 of the measurement. After obtaining a constant baseline value as the result of saliva addition (AvCoF1), the model solution (MS) is added. The Av.CoF2 is calculated using only the data points after stabilization of the interaction between saliva and MS. Δμ is the difference between Av.CoF2 and Av.CoF1.

FIG. 8 Results of the sensory assessment of Example 11. Mean rating of astringency by the panelists on a scale of 1 to 5, with 1 being the lowest and 5 being the highest score.

FIG. 9 Particle size distribution of both samples analyzed in Example 13, by volume.

FIG. 10 Particle size distribution of both samples analyzed in Example 13, by number.

### DETAILED DESCRIPTION

### Yeast Oleosome Composition

The present inventors have developed yeast oleosome compositions characterized by particularly favorable physical stability and sensory properties, especially in view of use as an emulsion, in any application such as for example in food applications (for example in substitutes for dairy products, in sauces, in soups, and in substitutes for meat products or egg products) or cosmetic applications (for example creams, lotions and the like). Yeast oleosomes are defined as stable oil bodies (also called lipid droplets) from yeast origin having a core of triglycerides surrounded by a membrane composed of phospholipids and proteins.

The present inventors have in particular optimized the composition and properties of the yeast oleosome composition to obtain a pleasant mouthfeel, preferably matching the mouthfeel and other sensory properties of milk or cream. Such advantageous properties are conferred to the present compositions by the combination of oleosomes with at least one isolated yeast cell component selected from chitin, β-D-glucan and mannoprotein, wherein the at least one yeast cell wall component is released (or in other words isolated) from the cell wall structure. In a preferred aspect, the yeast oleosome composition of the invention comprises chitin, β-D-glucan and mannoprotein. The terms “released” or “isolated” from the yeast cell wall structure herein means that the yeast cell wall component is present in the composition in free form, i.e. separated from the yeast cell wall structure, and is not part of the structure of a yeast cell wall debris. The feature that the yeast cell wall component is “released” or “isolated” from the yeast cell wall structure is important to make the yeast cell wall component available for interaction with other components of the composition, such as the oleosomes, and/or for interaction with the environment to which the composition is exposed, such as the oral cavity and/or other molecules to which the composition of the invention is admixed (such as other ingredients of a food product comprising the composition of the invention).

The at least one yeast cell wall component can be present in the yeast oleosome composition either in solubilized or suspended form, or it can be associated with the yeast oleosome membrane or it can be partly solubilized or suspended and partly associated with the yeast oleosome membrane. In a preferred aspect, the at least one yeast cell wall component is associated with the yeast oleosome membrane, preferably through non-covalent bonds, such as electrostatic interactions, hydrogen bonds or hydrophobic interactions. In an embodiment the composition comprises at least two yeast cell wall components selected from chitin, β-D-glucan and mannoprotein, one or two of these yeast cell walls components is (are) in solubilized or suspended form, and the other one or two component(s) is (are) associated with the yeast oleosome membrane. Preferably chitin, β-D-glucan and mannoprotein are all associated with the yeast oleosome membrane.

In a preferred aspect, the at least one isolated yeast cell wall component is present in the composition of the present invention in an amount of at least 0.3, preferably at least 0.4, more preferably at least 0.5, more preferably at least 0.6, more preferably at least 0.7, more preferably at least 0.8, more preferably at least 0.9, most preferably at least 1% by weight based on the total weight of the composition.

In a further preferred aspect, the composition of the present invention comprises beta-glucan in an amount of at least 0.3, preferably at least 0.4, more preferably at least 0.5, more preferably at least 0.6, more preferably at least 0.7, more preferably at least 0.8, more preferably at least 0.9, most preferably at least 1% by weight based on the total weight of the composition.

The compositions of the present invention are the result of a process that ensures the efficient lysis of the yeast cell wall, allowing the release of chitin, β-D-glucan and mannoprotein from the yeast cell wall and that retains the structure of the oleosome. An excessively soft process would not break the cell wall or would fail to liberate chitin, β-D-glucan and mannoprotein. To the contrary an excessively harsh process would break the cell wall, but would also break the structure of the oleosomes, thus negatively impacting the emulsification properties and the mouthfeel of the composition.

The presence of at least one isolated yeast cell wall component selected from chitin, β-D-glucan and mannoprotein advantageously impacts the viscosity of the composition. Indeed, the viscosity of a composition comprising oleosomes in combination with such yeast cell wall component is characterized by a higher viscosity than the same composition not comprising such yeast cell wall component.

In a particular aspect, the composition of the invention is in the form of a dairy alternative composition. The compositions can be provided in liquid or solid form. When the composition is in liquid form, it is ready for use as a milk or cream alternative. When it is in solid form, the composition is to be reconstituted with water before consumption as a milk or cream alternative, in the same way as for dehydrated dairy products.

In a preferred aspect, the particle size of the oleosome composition of the invention is characterized by a mean diameter by volume of 0.2 to 7 μm as measured by dynamic light scattering, preferably using a Zetasize Ultra (Malvern Instruments). The particle size can vary within the above-recited range, depending on the composition type. Preferably, for milk alternative applications, the mean diameter by volume is of 0.2 to 2 μm, preferably 0.2 to 1 μm, more preferably 0.2 to 0.8 μm, more preferably 0.4 to 0.8 μm even more preferably 0.6. to 0.8 μm, or 0.2 to 0.6 μm, such as 0.2 to 0.5 μm, whereas for cream alternative applications, the mean diameter by volume is of 0.4 to 7 μm. The larger particles are more appropriate for cream, as they provide a creamier mouthfeel to the composition.

The particle size is a determining parameter that confers to the composition its advantageous physical and sensory properties, such as advantageous physical stability, wettability and improved mouthcoating properties, leading to optimal lubrication in the mouth upon consumption of the product, as will be shown in the examples below.

In preferred aspect, the density of the yeast oleosome composition is of 0.8 to 1.1 g/ml. The density of the composition also plays a key role in the fine-tuning of the sensory properties of the yeast oleosome composition of the invention. Within the above-mentioned range, the density of the composition preferably differs slightly between a composition for application as a milk substitute and for application as a cream substitute. For a milk substitute, the density is preferably of 0.8 to 1.1 g/ml, more preferably of 0.85 to 1.0 g/ml. For a cream substitute, the density is preferably of 0.85 to 1.2 g/ml, more preferably of 0.9 to 1.1 g/ml.

In a preferred aspect, the zeta potential at the surface of the oleosomes in the composition is in the range of −40 to −5 mV, preferably −40 to −8 mV, more preferably −40 to −10 mV, even more preferably −40 to −20 mV, most preferably −30 to −20 mV at physiological pH. Such zeta potential is advantageous because within such range, the electrostatic interactions between the oleosomes are sufficiently low to avoid aggregation of the oleosomes and ensure proper physical stability of the composition. A zeta potential within the present range also contributes to the interaction of the yeast oleosome membrane with the polysaccharides. The zeta potential varies within this range, depending on the proteins present in the oleosome membrane.

In a preferred aspect the pH of the oleosome composition is of 5 to 8, preferably 6 to 7. Such pH range is preferred because it impacts the net charge of the oleosomes and positively impact the physical stability of the composition over time.

In a particular aspect, the yeast oleosome composition of the invention is in liquid form and has a total solids content of 2 to 45 wt %. Within this range, the total solids content of a yeast oleosome composition according to the invention in liquid form can be adjusted, depending on the intended application. The total solids content will be higher for a cream alternative than for a milk alternative, for example. Preferably, the total solids content of a yeast oleosome composition according to the invention particularly suitable as a milk alternative is of 2 to 12 wt %, preferably 2 to 10 wt %, more preferably 2 to 8 wt %, more preferably 2 to 6 wt %, even more preferably 2 to 5 wt %, based on the total weight of the composition, whereas the total solids content of a yeast oleosome composition according to the invention suitable as a cream alternative is of 15 to 45 wt %, more preferably 16 to 45 wt %, more preferably 20 to 45 wt % preferably 30 to 45 wt %, more preferably 35 to 45 wt %, more preferably 40 to 45 wt %, for example 16.6 wt % or 42 wt %, based on the total weight of the composition. The large range of total solids applicable for cream alternative applications makes it possible to vary the total solids content to produce alternatives to the diverse type of creams traditionally available in the dairy applications, such as half cream, whole cream, double cream, coffee cream and the like.

A yeast oleosome composition according to the present invention in solid form (i.e. a composition that is a dried version of the a yeast oleosome composition according to the present invention in liquid form, which can be obtained by spray-drying, by lyophilization, by freeze-drying or by any other suitable drying method, preferably by lyophilization, to form a lyophilizate) preferably has a residual moisture content of 3 to 4 wt %, i.e. a total solids content of 96 to 97 wt %. Typically, such compositions in solid form or lyophilizates are reconstituted with water before consumption. The amount of water used for reconstitution can vary, depending on the intended dairy alternative to be produced. The composition is preferably reconstituted with an amount of water suitable to obtain a final total solids amount as recited above, for a milk alternative and a cream alternative, respectively.

In a particular aspect, the yeast oleosome composition of the invention in liquid form has a fat content of 1.25 to 60 wt %, preferably 1.25 to 50 wt %, such as 1.25 to 38 wt %, based on the total weight of the composition. Within this range, the fat content of a yeast oleosome composition according to the invention can be adjusted, depending on the intended application. The fat content will be higher for a cream alternative than for a milk alternative, for example. Preferably, a yeast oleosome composition according to the invention particularly suitable as a milk alternative has a total fat content of 1.25 to 4 wt %, more preferably 1.25 to 3 wt %, even more preferably 1.25 to 2 wt %, even more preferably 1.25 to 1.6 wt %, most preferably 1.3 to 1.5 wt %, for example 1.4 wt %, based on the total weight of the composition. Preferably, the fat content in a yeast oleosome composition according to the invention suitable as a cream alternative is preferably of 17 to 60 wt %, preferably 17 to 50 wt %, preferably 17 to 38 wt %, preferably of 20 to 35 wt %, more preferably 25 to 35 wt %, even more preferably 28 to 32 wt %, most preferably 30 wt %, based on the total weight of the composition. The large range of fat content applicable for cream alternative applications makes it possible to vary the fat content to produce alternatives to the diverse type of creams traditionally available in the dairy applications, such as half cream, whole cream, double cream, coffee cream and the like.

In a preferred aspect, the yeast oleosome composition of the present invention has a saturated fat content of 0.35 to 40 wt %, preferably 0.35 to 30 wt %, preferably 0.35 to 19 wt %, based on the total weight of the composition. Within this range, the saturated fat content of a yeast oleosome composition will vary, depending on the total amount of fat. The total amount of fat and therefore also the saturated fat content will be higher for a cream alternative than for a milk alternative, for example. Preferably, a yeast oleosome composition according to the invention particularly suitable as a milk alternative has a total saturated fat content of 0.35 to 2 wt %, more preferably 0.35 to 1.5 wt %, even more preferably 0.35 to 1 wt %, even more preferably 0.35 to 0.5 wt %, for example 0.4 wt %, based on the total weight of the composition. Preferably, the fat content in a yeast oleosome composition according to the invention suitable as a cream alternative is preferably of 4.5 to 40 wt %, preferably 4.5 to 30 wt %, preferably 4.5 to 19 wt %, preferably of 4.5 to 15 wt %, more preferably 4.5 to 10 wt %, even more preferably 4.5 to 9 wt %, for example 8.5 wt %, based on the total weight of the composition.

In a preferred aspect, the yeast oleosome composition of the present invention has a carbohydrate content of up to 15 wt %, based on the total weight of the composition. Within this range, the carbohydrate content of a yeast oleosome composition will vary, depending on the intended application. The total amount of carbohydrates will be higher for a cream alternative than for a milk alternative, for example. In preferred aspect, a yeast oleosome composition according to the invention particularly suitable as a milk alternative has a carbohydrate content of up to 3 wt %, preferably of up to 2 wt %, more preferably up to 1.5 wt %, more preferably up to 1 wt %, even more preferably up to 0.5 wt % and most preferably 0.2 wt %, based on the total weight of the composition. The carbohydrate content in a yeast oleosome composition according to the invention suitable as a cream alternative is preferably of 0.5 to 15 wt %, preferably of 1 to 10 wt %, more preferably 1 to 8 wt %, even more preferably 1 to 6 wt %, most preferably 4 wt %, based on the total weight of the composition.

In a preferred aspect, the yeast oleosome composition of the present invention has a protein content of 0.1 to 7 wt %, based on the total weight of the composition. Within this range, the protein content of a yeast oleosome composition will vary, depending on the intended application. The total amount of protein will be higher for a cream alternative than for a milk alternative, for example. Preferably a yeast oleosome composition according to the invention particularly suitable as a milk alternative has a protein content of 0.1 to 1.5 wt %, preferably of 0.1 to 1 wt %, more preferably 0.1 to 0.8 wt %, more preferably 0.1 to 0.5 wt % and most preferably 0.3 wt %, based on the total weight of the composition. The total protein content in a yeast oleosome composition according to the invention suitable as a cream alternative according to the invention is preferably of 2.5 to 7 wt %, preferably of 3 to 7 wt %, more preferably 4 to 7 wt %, even more preferably 5 to 7 wt %, most preferably 6.5 wt %, based on the total weight of the composition.

In a preferred aspect, a yeast oleosome composition according to the invention particularly suitable as a milk alternative has a total solids content of 2 to 10 wt %, a total fat content of 1.25 to 4 wt %, a saturated fat content of 0.35 to 2 wt %, a total carbohydrate content of up to 3 wt % and a total protein content of 0.1 to 1.5 wt %, based on the total weight of the composition.

In another preferred aspect, a yeast oleosome composition according to the invention particularly suitable as a cream alternative has a total solids content of 30 to 40 wt %, a total fat content of 17 to 38 wt %, a saturated fat content of 4.5 to 19 wt %, a total carbohydrate content of 0.5 to 15 wt % and a total protein content of 2.5 to 7 wt %, based on the total weight of the composition.

The yeast oleosome can originate from any oleaginous yeast, preferably selected from the genera Yarrowia, Candida, Rhodotorula, Rhodosporidium, Cryptococcus, Trichosporon, Cutaneotrichosporon, Lipomyces, Papiliotrema, Hannaella, Sporidiobolus, Kodamaea, Pichia, Saitozyma, Cyberlindnera, Meyerozyma, Piskurozyma and mixtures thereof. The oleaginous yeast is preferably selected from the species Yarrowia lipolytica, Candida 107, Candida tropicalis, Candida utilis, Rhodotorula glutinis, Rhodotorula mucilaginosa, Rhodotorula babjevae, Rhodotorula sphaerocarpa, Rhodotorula graminis, Rhodosporidium toruloides, Rhodosporidium fluviale, Cryptococcus curvatus, Trichosporon pullulan, Trichosporon asahii, Cutaneotrichsporon oleaginosus, Cutaneotrichsporon curvatum and Lipomyces lipofer, Lipomyces starkeyi, Lipomyces tretrasporus, Lipomyces mesembrius, Schwanniomyces occidentalis, Papiliotrema terrestris, Papiliotrema flavescens, Papiliotrema laurentii, Sporidiobolus ruineniae, Kodamaea ohmeri, Pichia manshurica, Saitozyma podzolica, Cyberlindnera saturnus, Meyerozyma guilliermondii, Metschnikowia pulcherrima and mixtures thereof. Preferably the oleaginous yeast is selected from Yarrowia, Candida, Rhodotorula, Rhodosporidium, Cryptococcus, Trichosporon, Cutaneotrichosporon, Lipomyces, Papiliotrema, Hannaella, Sporidiobolus, Kodamaea, Pichia, Saitozyma, Cyberlindnera, Meyerozyma, Piskurozyma and mixtures thereof. The oleaginous yeast is preferably selected from the species Yarrowia lipolytica, Candida 107, Candida tropicalis, Candida utilis, Rhodotorula glutinis, Rhodotorula mucilaginosa, Rhodotorula babjevae, Rhodotorula sphaerocarpa, Rhodotorula graminis, Rhodosporidium toruloides, Rhodosporidium fluviale, Cryptococcus curvatus, Trichosporon pullulan, Trichosporon asahii, Cutaneotrichsporon oleaginosus, Cutaneotrichsporon curvatum and Lipomyces lipofer, Lipomyces starkeyi, Lipomyces tretrasporus, Lipomyces mesembrius, Schwanniomyces occidentalis, Papiliotrema terrestris, Papiliotrema flavescens, Papiliotrema laurentii, Sporidiobolus ruineniae, Kodamaea ohmeri, Pichia manshurica, Saitozyma podzolica, Cyberlindnera saturnus, Meyerozyma guilliermondii and mixtures thereof. Most preferably, the oleaginous yeast is Yarrowia lipolytica.

The yeast oleosome compositions of the invention are advantageously physically stable. Typically, a yeast oleosome suitable as a milk alternative as disclosed above, is stable for at least two weeks at room temperature and a yeast oleosome composition suitable as a cream alternative such as disclosed above is stable for at least two days at room temperature.

The yeast oleosome compositions of the present invention are also characterized by advantageous sensory properties, such as a pleasant mouthfeel that successfully mimics dairy products. Mouthfeel is a result of several parameters, including viscosity (rheology) and surface properties (tribology) of the composition. The present inventors have found that the compositions of the invention are characterized by viscosity and surface properties closer to dairy milk/cream than compositions based on plant oleosomes, as shown in the examples below. In particular, they have found that the present compositions had higher viscosity, as well as a lower friction coefficient as a function of sliding velocity than commercial dairy alternatives based on plant oleosomes. Therefore, the present compositions were found to provide both rheological and tribological properties that provide an improved mouthfeel and mouthcoating, compared to formulations based on plant oleosomes.

Viscosity is preferably defined as the viscosity as measured by any known method, for example using an Anton Paar Rheometer MCR302 with a plate configuration or any similar equipment.

The friction coefficient measures the friction and lubrication between interacting surfaces in relative motion and is therefore a strong indicator of the friction generated between food particles and the oral surfaces, friction between tongue and palate and the adherence of food to the oral cavity, which all play an important role in the mouthfeel and mouthcoating properties of a food product. The friction coefficient is measured as a function of the velocity of the movement of the surfaces at stake. Low velocity movements, such as those at stake in the oral cavity are designated as the boundary lubrication regime. Under such conditions the wetting and adsorption properties of the product to the surfaces of the oral cavity are key parameters. The higher the wetting properties, the lower the friction coefficient. In turn, the lower the friction coefficient, the lower the friction in the oral cavity and therefore the higher the smoothness and lubricating properties of the product. The friction coefficient is therefore a key parameter determining consumer acceptance of a product intended to be perceived as creamy, such as dairy products, and in particular cream.

In a preferred aspect, the yeast oleosome compositions of the present invention are characterized by a friction coefficient of 0.01 to 0.5, preferably 0.01 to 0.2, as measured by the method described in the following examples. The friction is preferably of 0.02 to 0.5, more preferably 0.02 to 0.2 when the yeast oleosome composition is a milk alternative and of 0.01 to 0.5, more preferably 0.01 to 0.2 when the yeast oleosome composition is a cream alternative.

### Process

The compositions of the present invention are preferably obtained by a process comprising the steps of:
a) providing oleaginous yeast cells;
b) lysing the cell wall; and
c) separating the oleosomes from the other yeast cell components.

The yeast cells can optionally be subjected to pre-treatment, such as:
i. Washing with water, preferably warm water;
ii. Washing with an alkaline solution;
iii. Washing with an acidic solution; and/or
iv. Enzymatic digestion of the cell wall.

Step b) can be performed by chemical or mechanical means. Suitable chemical means include:
i. alkaline treatment, preferably by soaking the yeast cells in an aqueous medium at pH 8 to 12 for 1 to 36 hours, preferably 2 to 36 hours;
ii. contacting the yeast cells with an organic solvent such as ethanol, methanol or heptane;
iii. autolysis;
iv. enzymatic treatment, preferably using one or more hydrolase(s), applied to the washed biomass and suspended at a concentration of 50 to 200 g/L in water or a suitable pH buffer with an incubation temperature of 30 to 50° C. and an incubation time of 0.5 to 8 hours with low stirring or shaking, to allow the degradation of cell wall biopolymers);
and combinations thereof.

The one or more hydrolase(s) is preferably selected from one or more protease(s), glucanase(s), mannanase(s), chitinase(s), nuclease(s), beta-glucosidase(s), cellulase(s), xylanase(s), pectinase(s) and combinations thereof. Preferably, it is one or more protease(s) and/or glucanase(s).

Preferred chemical means for the cell lysis include:
i. alkaline treatment, preferably by soaking the yeast cells in an aqueous medium at pH 8 to 12 for 1 to 36 hours, preferably 2 to 36 hours;
ii. autolysis, by heating the cells in the end of the fermentation to a temperature of 50° C. or more, reducing the stirring and stopping the aeration until spontaneous lysis of the yeast cell occur (under the action of the endogenous enzymes);
iii. enzymatic treatment, preferably using one or more hydrolases (as defined above), applied to the washed biomass and suspended at a concentration of 50 to 200 g/L in water or a suitable pH buffer with an incubation temperature of 30 to 50° C. and an incubation time of 0.5 to 8 hours with low stirring or shaking, to allow the degradation of cell wall biopolymers);
and combinations thereof.

Such preferred chemical means are particularly advantageous because they are successful in breaking the cell wall, thus releasing the yeast cell wall components chitin, β-D-glucan and mannoproteins, while preserving the structure of the oleosomes.

Suitable mechanical means of the cell wall lysis of step b) include high pressure homogenization, preferably with 1 to 10 passes at a pressure of 500 to 3000 bar, more preferably with 2 to 10 passes at a pressure of 700 to 3000 bar

When high pressure homogenization is used, the number of passes and the homogenization pressure can advantageously be adapted, when high pressure homogenization is combined with chemical means for lysing the membrane. For example, 1 to 10 passes and a pressure of 500 to 3000 bar is sufficient when the high-pressure homogenization is combined with prior enzymatic treatment, whereas it is preferred to perform the high-pressure homogenization with 2 to 10, preferably 2 to 5 passes at a pressure of 700 to 3000 bar, preferably 700 to 2000 bar, in particular when the high pressure homogenization is performed after alkaline treatment. Preferably high-pressure homogenization is performed in high-pressure homogenizer comprising a nozzle, as it contributes to breaking down the cells.

High-pressure homogenization as disclosed herein is particularly advantageous over other mechanical means of lysing the yeast cell wall, such as bead milling, ultrasound treatment and microwave treatment, in that it is successful in breaking the cell wall, thus releasing the yeast cell wall components chitin, β-D-glucan and mannoproteins, while preserving the structure of the oleosomes, as shown in Example 13 below. High-pressure homogenization is also advantageous in terms of yield and allows to control the particle size.

Chemical and mechanical means for lysing the cell wall can advantageously be combined with each other. Particularly advantageous combinations are:
i. alkaline treatment, preferably by soaking the yeast cells in an aqueous medium at pH 8 to 12 for 1 to 36 hours, preferably 2 to 36 hours, followed by high pressure homogenization, preferably with 1 to 10 passes at a pressure of 500 to 3000 bar, more preferably with 2 to 10 passes at a pressure of 700 to 3000 bar;
ii. enzymatic treatment, preferably using one or more hydrolases (as defined above), applied to the washed biomass and suspended at a concentration of 50 to 200 g/L in water or a suitable pH buffer with an incubation temperature of 30 to 50° C. and an incubation time of 0.5 to 8 hours with low stirring or shaking, to allow the degradation of cell wall biopolymers), followed by high pressure homogenization, preferably with 1 to 10 passes at a pressure of 500 to 3000 bar, preferably with prior pre-treatment by washing with water or an alkaline solution;
iii. autolysis, by heating the cells in the end of the fermentation to a temperature of 50° C. or more, reducing the stirring and stopping the aeration until spontaneous lysis of the yeast cell occur (under the action of the endogenous enzymes), followed by high pressure homogenization, preferably with 1 to 10 passes at a pressure of 500 to 3000 bar, preferably with 2 to 10 passes at a pressure of 700 to 3000 bar;

In a preferred aspect, cell lysis is performed by one of the following means:
i. alkaline treatment, preferably by soaking the yeast cells in an aqueous medium at pH 8 to 12 for 1 to 36 hours, preferably 2 to 36 hours, followed by high pressure homogenization, preferably with 2 to 10 passes at a pressure of 700 to 3000 bar;
ii. autolysis, by heating the cells in the end of the fermentation to a temperature of 50° C. or more, reducing the stirring and stopping the aeration until spontaneous lysis of the yeast cell occur (under the action of the endogenous enzymes); and
iii. enzymatic treatment, preferably using one or more hydrolases (as defined above), applied to the washed biomass and suspended at a concentration of 50 to 200 g/L in water or a suitable pH buffer with an incubation temperature of 30 to 50° C. and an incubation time of 0.5 to 8 hours with low stirring or shaking, to allow the degradation of cell wall biopolymers), followed by high pressure homogenization, preferably with 1 to 10 passes at a pressure of 500 to 3000 bar,

The separation step is preferably performed by
i. decantation, preferably using a disk stack at 5000 to 20000 g for 10 seconds to 5 minutes,
ii. centrifugation, under any suitable condition, preferably at 3000 to 30000 g, preferably 3000 to 20000 g, preferably 3000 to 10000 g, such as 7000 g in disc centrifuge, such as a continuous disk stack centrifuge, preferably with a residence time of 10 seconds to 10 minutes, preferably 10 seconds to 5 minutes, preferably 30 seconds to 5 minutes for example 1 minute. Preferably, the temperature is of 5 to 85° C., preferably 40 to 65° C.
iii. filtration, preferably in cross counter flow, such as by filtration using polymeric or ceramic membranes with pore sizes from 10 kDa to 300 kDa, and from 0.2 μm to 20 μm or
iv. Flocculation, preferably by contacting the composition with a flocculant, preferably for 1 to 24 hours at a temperature of 2 to 60° C. Any flocculant known in the art can be used. Preferably the flocculant is selected from inorganic salts such as CaCl2, or a natural flocculant such as chitosan, cellulose and the like. The flocculant is preferably used in an amount of 0.1 to 50 mg/L.

Preferably, the separation step is performed by decantation, centrifugation or filtration, as described above. More preferably, it is performed by decantation, as described above.

In a particularly preferred aspect, the compositions of the present invention are obtained by a process comprising the steps of:
a) providing oleaginous yeast cells, wherein the yeast cells are preferably washed and optionally weakening the cell walls by one or more of the following pre-treatments
   i. alkaline treatment, preferably by soaking the yeast cells in an aqueous medium at pH 8 to 12 for 1 to 36 hours, preferably 2 to 36 hours;
   ii. enzymatic treatment, preferably using one or more hydrolases (as defined above), applied to the washed biomass and suspended at a concentration of 50 to 200 g/L in water or a suitable pH buffer with an incubation temperature of 30 to 50° C. and an incubation time of 0.5 to 8 hours with low stirring or shaking, to allow the degradation of cell wall biopolymers); and/or
   iii. autolysis, by heating the cells at the end of the fermentation to a temperature of 50° C. or more, reducing the stirring and stopping the aeration until spontaneous lysis of the yeast cell occurs (under the action of the endogenous enzymes);
b) lysing the cell wall by
   i. Alkaline treatment, preferably by soaking the yeast cells in an aqueous medium at pH 8 to 12 for 1 to 36 hours, preferably 2 to 36 hours;
   ii. contacting the yeast cells with an organic solvent such as ethanol, methanol or heptane;
   iii. autolysis, by heating the cells in the end of the fermentation to a temperature of 50° C. or more, reducing the stirring and stopping the aeration until spontaneous lysis of the yeast cell occurs (under the action of the endogenous enzymes);
   iv. enzymatic treatment, preferably using one or more hydrolases (as defined above), applied to the washed biomass and suspended at a concentration of 50 to 200 g/L in water or a suitable pH buffer with an incubation temperature of 30 to 50° C. and an incubation time of 0.5 to 8 hours with low stirring or shaking, to allow the degradation of cell wall biopolymers);
   v. high pressure homogenization, preferably with 1 to 10 passes at a pressure of 500 to 3000 bar, more preferably with 2 to 10 passes at a pressure of 700 to 3000 bar; or
   vi. any combinations of combinations of any two or more of the means provided in items i. to v.; and
c) separating the oleosomes from the other yeast cell components by
   i. decantation, preferably using a disk stack at 5000 to 20000 g for 10 seconds to 5 minutes
   ii. centrifugation
   iii. filtration.

In optional further step d), the composition obtained in the end of step c) is dried by
i. Spray drying or
ii. Lyophilization.

In a preferred aspect of the invention, no washing step is performed after the separation step. This aspect is advantageous in that it avoids removing of the “isolated” yeast cell wall component such as described above that are recovered by the separation step.

### Product by Process

In another aspect, the present invention relates to a yeast oleosome composition obtained or obtainable by the process of the present invention.

### Lyophilizate

In an embodiment, the present invention provides a lyophilizate of any composition of the present invention. In such case, a composition according to the invention, as described above is dried in any known manner such as by spray-drying, freeze-drying, lyophization and the like.

### Products

In another aspect the invention relates to product comprising the yeast oleosome composition of the invention or the lyophilizate of the invention. Such product is preferably a food product or a beverage or a cosmetic product comprising the yeast oleosome composition of the present invention. Preferably it is a food product or beverage.

Such food product or beverage can be any kind of food product or beverage, preferably it is a food product comprising an emulsion, more preferably it is a food product that serves as an alternative to food products and beverages can be produced from milk or that can comprise milk. For example, the food product or beverage is a yogurt, a cheese, a curd, a cream, a mousse, a sauce, a soup, a mayonnaise, a smoothie, a juice, a dessert, a bread, a pastry, a cake, an infant formula, a growing-up milk, a creamed or milked coffee, tea or chocolate, an ice cream, or a confectionary product (such as a chocolate or a candy).

Ice creams product prepared with the oleosome composition of the invention is advantageously very stable and exhibits properties closely mimicking those of dairy-based ice cream, in particular in terms of melting behavior, tribology (i.e. mouthfeel) and rheology. Such advantageous proprerties are advantageously obtained with very simple ice cream formulations comprising only the oleosome composition and sugar (Ice cream C), or with more dilute formulation comprising water and optionally flavours, additional fats and/or stabilisers such as gum. The oleosome composition of the present invention provides a very advantageous vegan alternative to dairy ice cream with clean label.

In a preferred aspect, the food product or beverage comprises at least one astringent component, preferably polyphenols.

Suitable cosmetic products include creams, lotions and the like.

### Uses

The present invention also relates to the use of the yeast oleosome composition of the invention for improving the sensory properties, such as improving the mouthfeel, improving the flavor, improving the mouthcoating, reducing the off-flavor, and/or reducing the off-taste, of a food or beverage product or of an edible ingredient. In a preferred aspect, the sensory properties of the food or beverage product or of the edible ingredient are improved compared to the same such food or beverage product or edible ingredient that does not contain the oleosome composition. In a preferred aspect, the off-taste that is reduced is selected from astringency and/or bitterness.

In particular, the composition of the present invention has proven to be useful in reducing the intensity of astringency of a food product or beverage, particularly those comprising at least one astringent component. Therefore, the present invention relates to the use of a yeast oleosome composition as described above for reducing the astringency of a food product or beverage, preferably of a food product or beverage comprising at least one astringent component. Also, the yeast oleosome composition of the invention can be used for reducing the perception of astringency by a subject upon consumption of a food product comprising at least one astringent component.

In a preferred aspect, such uses comprise addition of the yeast oleosome composition described above to the food product or beverage comprising at least one astringent component or the consumption of the yeast oleosome composition before, after or simultaneously with the consumption of the food product or beverage. When the yeast oleosome composition of the invention is consumed before or after the consumption of the food product or beverage comprising at least one astringent component, the yeast oleosome composition of the invention is preferably consumed up to 15 minutes, preferably up to 10 minutes, more preferably up to 8 minutes, more preferably up to 6 minutes, more preferably up to 5 minutes, more preferably up to 4 minutes, more preferably up to 3 minutes, even more preferably up to 2 minutes, most preferably up to 1 minute before or after the consumption of the food product or beverage comprising at least one astringent component. In a most preferred aspect, the yeast oleosome composition is added to the food product or beverage comprising at least one astringent component or the yeast oleosome composition is consumed simultaneously with the food product or beverage comprising at least one astringent component.

Astringency is defined as a sensory attribute often described in terms of a dry, puckering, or rough mouthfeel. The at least one astringent component is preferably selected from the group consisting of salts of multivalent metallic cations, ethanol, organic acids and/or polyphenols and mixtures thereof. In a preferred aspect, the food product or beverage comprising at least one astringent component comprises an edible material comprising polyphenols, such as tea (in particular green tea and black tea), wine (in particular red wine), cocoa, coffee, fruits (like elderberries, cherries, blueberries, strawberries, blackberries, blackcurrants, raspberries, olives, plums and apples), vegetables (like spinach, shallots, artichokes, red chicory, red onion and green chicory), legumes (like pea, black beans and white beans), herbs and spices (like cloves, star anise, turmeric, peppermint, oregano, sage, rosemary, thyme and curry powder), seeds and nuts (like flaxseed, chestnuts, hazelnut, pecan nut, almonds, walnuts and celery seeds) and/or cereals (like soy or tempeh).

Astringency is thought to arise from an increase of the friction in the mouth upon consuming an astringent food or beverage. It has been found that astringent compounds like polyphenols bind to proteins in saliva, causing the proteins to precipitate or change their conformation. This reduces the lubrication provided by saliva, leading to increased friction in the mouth and the characteristic sensation of astringency (Sarkar, A., Andablo-Reyes, E., Bryant, M., Dowson, D., & Neville, A. (2019), Lubrication of soft oral surfaces, Current Opinion in Colloid & Interface Science, 39, 61-75). The yeast oleosome composition of the invention is surprisingly able to reduce the friction in the mouth when combined with an astringent component, as shown in the examples below.

### EXAMPLES

### Example 1: Process for the Preparation of a Yeast Oleosome Composition According to the Invention

Yarrowia lipolytica cells were first separated from the broth by centrifugation. The obtained biomass was washed with water at a biomass to water ratio of 1:2 and the cells were recovered by centrifugation.

To lyse the cell wall, the cells were then subjected to an alkaline treatment by soaking the biomass twice in an aqueous solution at a pH in the range of 8 to 12 for 2 to 36 hours. The biomass was then subjected to homogenization and was passed from 2 to 10 times in the homogenizer, at a pressure of 700 to 3000 bar.

The oleosome composition was then separated from the lysed cell composition by decantation using a disk stack at 7000 g for 1 minute and the oleosome composition was collected comprising oleosomes and chitin, β-D-glucan and mannoproteins.

### Example 2: Process for the Preparation of a Yeast Oleosome Composition According to the Invention

Yarrowia lipolytica cells were cultured in an appropriate broth. In the end of the fermentation, the bioreactor was heated to 50° C., stirring was reduced and aeration was stopped. These conditions were maintained until spontaneous lysis of the yeast cells under the action of endogenous enzymes. The resulting medium with lysed cells was then introduced into a disk stack decanter and subjected to decantation at 7000 g for 1 minute and the oleosome composition was collected, comprising oleosomes and chitin, β-D-glucan and mannoproteins.

### Example 3: Process for the Preparation of a Yeast Oleosome Composition According to the Invention

Yarrowia lipolytica cells were cultured in an appropriate broth. In the end of the fermentation, the bioreactor was heated to 50° C. for 12 hours, stirring was reduced and aeration was stopped. These conditions were maintained until spontaneous weakening of the yeast cells under the action of endogenous enzymes.

The yeast cell walls were then lysed and extracted by first performing high pressure homogenization. The cells were passed from 2 to 5 times in the homogenizer, at a pressure of 700 to 3000 bar. The cells were then subjected to an enzymatic treatment (2% dw) using a neutral protease for 2 hours.

After cell wall lysis the oleosome composition was separated from the broken walls by centrifugation at 5000 g for 1 hour at a temperature of 50° C.

### Example 4: Process for the Preparation of a Yeast Oleosome Composition According to the Invention

Yarrowia lipolytica cells were cultured in an appropriate broth. In the end of the fermentation, the cell walls were weakened by subjecting the cells to an enzymatic treatment with a pectinase (4% dw) for 2 hours.

The yeast cell walls were then lysed and extracted by first heating the weakened cells to 50° C. until spontaneous lysis of the yeast cells under the action of endogenous enzymes. The cells were then additionally subjected to high pressure homogenization (2 passes at 1500 bar with a high-pressure homogenizer equipped with nozzle.

After cell wall lysis the oleosome composition was separated from the broken walls by centrifugation at 5000 g for 1 hour at a temperature of 60° C.

### Example 5: Yeast Oleosome Compositions of the Invention

TABLE 1
[Part I]

| | Particle size¹ | Density | Zeta potential | |
|---|---|---|---|---|
| Sample | μm | g/L | mV | pH |
| A1 | 0.2 | 0.98 | −20 | 6.7-7 |
| A2 | 0.7 | 0.98 | −20 | 6.7-7 |
| Cultivated | 1.5 | 0.83 | −30 | 6.7-7 |
| Cream | | | | |

¹Mean diameter, as measured by dynamic light scattering using a Zetasizer Ultra (Malvern Instruments)

TABLE 1
[Part II]

| | Total | Fat | Protein | Carbohydrate |
|---|---|---|---|---|
| | solids | content | content | content |
| Sample | wt %² | wt %² | wt %² | wt %² |
| A1 | 2 | 1.25 | 0.2 | 0.4 |
| A2 | 2 | 1.25 | 0.2 | 0.4 |
| Cultivated | 44 | 24 | 7 | 13 |
| Cream | | | | |

²based on the total weight of the composition

The properties of the samples were measured as follows.

### Fat Quantitation

Fat in the samples was quantified as methyl oleate equivalents after derivatization of the sample's fats to fatty acid methyl esters by GC. Freeze-dried sample was suspended 20 g/L in methanolic boron trifluoride and incubated at 85° C. for 10 minutes. The mixture was then returned to room temperature and four volumes of hexane were added. One microliter of organic phase was then injected on an 6860 N gas chromatograph equipped with HP-5 MS column (5% phenyl, polymethyl siloxane, 30 m×250 mm i.d.×0.25 μm) (Agilent Technologies AG). External standard solutions of methyl oleate at known concentration were used to quantify the fats based on chromatographic peak area.

### Protein Quantitation

Protein in the sample was quantified using the nitrogen content of freeze-dried samples, which is determined using a Vario Micro Cube organic elemental analyzer (Elementar Analysensysteme GmbH). The sample (3 mg) was loaded into a tin pan, which was then transferred to the analyzer, burned at X° C. and converted to nitrogen, steam and carbon dioxide by reaction with copper. The formed gasses were separated and quantified by the integrated thermal conductivity detector. Protein content was obtained by multiplying the detected N percentage by 6.25.

### pH Measurement

For each pH measurement, a pH meter Metrohm 780 was used. The measurements were performed after calibration.

### Example 6: Comparison of the Properties of the Compositions of the Invention with Plant Oleosome Compositions

Plant oleosome compositions were prepared from coconut, oat, almond cashew and soy. Each of the plant-based oleosomes (Oil droplets or oil bodies), was prepared by grinding the seed after overnight soaking at room temperature. The milky phase was separated via a cheesecloth filter. This extraction method of oleosomes is a common practice in academic work and industry. To be able to compare the different milky phases the total solid content was measured and adjusted via dilutions for all the samples. All the oleosome milky phases had a total solid content of 2%, such that the other properties of these oleosome compositions can be compared to the samples A1 and A2 for Example 5, having the same total solids content.

[Table 2] provides the properties of the comparative plant oleosome compositions prepared. The particle size and the pH were measured as described in Example 5.

The friction coefficient was measured as follows: The lubrication behavior of the samples was evaluated by a soft tribological protocol as has been described by Rudge, R. E. D., Fuhrmann, P. L., Scheermeijer, R., van der Zanden, E. M., Dijksman, J. A., & Scholten, E. (2021). A tribological approach to astringency perception and astringency prevention. Food Hydrocolloids, 121, 106951. A commercial glass ball was used on a three-PDMS pin set-up in a rheometer (Anton Paar Rheometer, MCR302). The loading force was 1 N and the friction was measured under a sliding velocity of 0.001 to 1 m/s. Every measurement was conducted with 1 ml of sample.

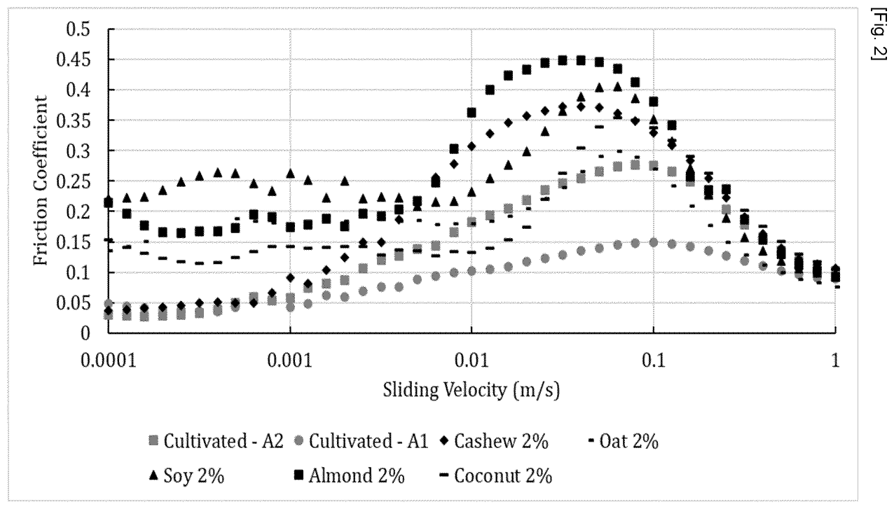

The results are provided in [FIG. 2]. The samples of the invention A1 and A2 tend to have low friction coefficient throughout the measured range, i.e. at low and high sliding velocity. In contrast, cashew, which has a friction coefficient close to that of the invention samples at low velocities, has a high friction coefficient at higher velocities. Coconut which has a friction coefficient between A1 and A2 at a velocity of 0.01 m/s has a much higher friction coefficient at lower and higher velocities. Finally oat, which has a friction coefficient similar as A2 at 0.1 m/s, has a much higher friction coefficient at velocities of 0.0001 and 0.001 m/s.

The friction coefficient at a sliding velocity of 0.1 m/s being of particular relevance for the assessment of the mouthfeel, such values are indicated in [Table 2] below for more clarity.

These results demonstrate that the compositions according to the present invention have an advantageously low friction coefficient, which indicates a better mouthfeel than compositions having a higher friction coefficient. In particular, sample A1 has a lower friction coefficient than all other samples throughout the measured range and has therefore the best mouthfeel among all tested samples.

TABLE 2

| | Particle | | friction coefficient |
|---|---|---|---|
| | size¹ | | (sliding Velocity |
| Sample | μm | pH | 0.1 m/s) |
| Coconut | 2-25 | 7 | 0.338 |
| Oat | 1.1 | 7 | 0.270 |
| Almond | 2.69-4 | 7 | 0.380 |
| Cashew | 2.96 | 7 | 0.330 |
| Soy | 0.27 | 7 | 0.351 |
| A1 | 0.2 | 6.7-7 | 0.148 |
| A2 | 0.7 | 6.7-7 | 0.275 |

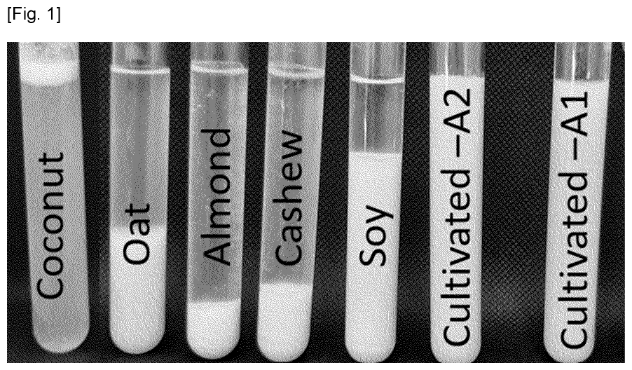

The stability of all samples has also been tested. The samples were placed in 15 mL containers. To follow the physical stability of the emulsions as a function of the time, the samples were stored at room temperature for 4 days. Pictures of the containers were taken to characterize the physical stability of the oleosomes based on time [FIG. 1]. All plant-based samples separated, while the samples A1 and A2 of the invention remained stable.

### Example 7: Comparison of the Properties of a Composition of the Invention Suitable as a Cream Alternative with Comparative Plant Oleosome Compositions

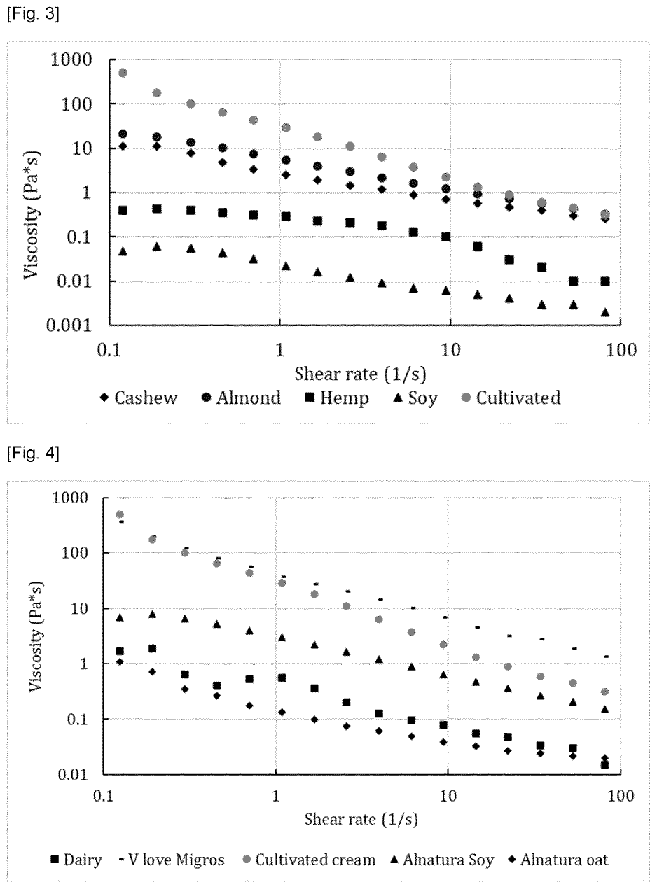

Plant-based oleosome creams was prepared from cashew, almond, hemp and soy by grinding the seed after overnight soaking at room temperature. The milky phase was separated via a cheesecloth filter. This extraction method of oleosomes is a common practice in academic work and industry. To be able to compare the different milky phases the total solid content was measured and adjusted via dilutions for all the samples. All the oleosome cream phases had a total solid content of 20 wt %, and were compared to an oleosome composition according to the invention having a total solids content of 20% (designated as (“Cultivated” in [FIG. 3]).

The viscosity of the “Cultivated” sample and of the comparative plant-based creams was measured as follows. The samples were measured in an Anton Paar Rheometer, MCR302 with a plate configuration. The viscosity values were obtained under the shear rate range of 0.1-100 1/s.

The results are provided in [FIG. 3]. The composition of the invention is advantageously characterized by the highest viscosity, which indicates a better mouthfeel of the composition of the invention than the comparative compositions.

### Example 8: Comparison of the Viscosity of a Composition of the Invention Suitable as a Cream Alternative with Commercial Plant Based Creams

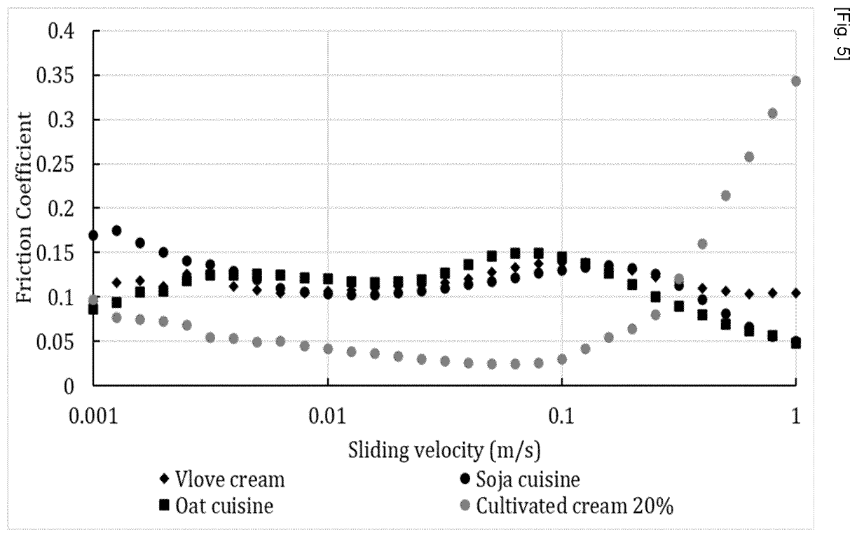

Plant-based creams were sourced from the supermarket Migros, Switzerland: V-Love® Plant-based cuisine (designated as “V love Migros” on [FIG. 4]), Alnatura® Soja Cuisine (designated as “Alnatura Soy” on [FIG. 4]) and Alnatura® Hafer Cuisine (designated as “Alnatura oat” on [FIG. 4]). The composition of Alnatura Soja Cuisine was water, sunflower oil 15%, soja beans 8% glucose syrup, xanthan gum, salt and vanilla extract. The composition of Alnatura Hafer Cuisine was: water, whole grain oat 9%, sunflower oil 7%, carob gum, guar gum and salt. The composition of V-Love® Plant-based cuisine was soja composition 68.5% (composed of water 95.6% and soja flour 4.4%), hydrogenated rapeseed oil 26.5%, glucose, maltodextrin, lactic esters of fatty acids mono- and diglycerides, methylcellulose, guar gum, carrageenan, sodium phosphate and salt.

The viscosity of the above-described commercial samples, of an oleosome composition according to the invention having a total solids content of 20% (designated as (“Cultivated cream” in [FIG. 4]) and of dairy cream with 20% total solids was measured as described in Example 7. The results are provided in [FIG. 4]. The sample of the invention (Cultivated cream) is advantageously characterized by a higher viscosity than both Alnatura samples, and also higher than the dairy cream, and a viscosity similar to that of the V-love sample at shear rates up to 1 s⁻¹. This indicates a better mouthfeel of the composition of the invention, compared to Alnatura samples and a similar mouthfeel as the V-love sample than the comparative compositions. This is particularly surprising because all tested commercial compositions contained texturizing ingredients, such as thickeners and/or emulsifiers, intended to improve viscosity and mouthfeel. Even though the composition of the invention did not contain any texturizing ingredient such as thickeners and emulsifiers, the cream alternative composition of the invention still exhibits a higher viscosity than most comparative samples and a similar viscosity to the highest viscosity comparative sample. This demonstrates that the compositions of the invention do not require texturizing agents and therefore are advantageously cleaner label non-dairy creams characterized by a good mouthfeel.

### Example 9: Comparison of the Friction Coefficient of a Composition of the Invention Suitable as a Cream Alternative with Commercial Plant Based Creams

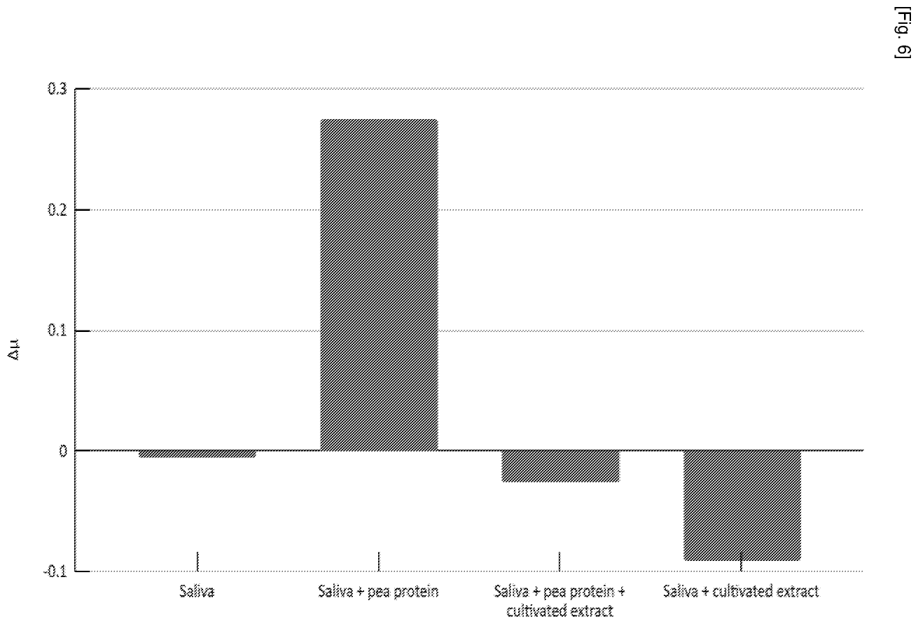

Plant-based creams were sourced from the supermarket Migros, Switzerland: V-Love® Plant-based cuisine (designated as “Vlove cream” on [FIG. 5]), Alnatura® Soja Cuisine (designated as “Soja cuisine” on [FIG. 5]) and Alnatura® Hafer Cuisine (designated as “Oat cuisine” on [FIG. 5]). The composition of Alnatura Soja Cuisine was: water, sunflower oil 15%, soja beans 8% glucose syrup, xanthan gum, salt and vanilla extract. The composition of Alnatura Hafer Cuisine was: water, whole grain oat 9%, sunflower oil 7%, carob gum, guar gum and salt. The composition of V-Love® Plant-based cuisine was: soja composition 68.5% (composed of water 95.6% and soja flour 4.4%), hydrogenated rapeseed oil 26.5%, glucose, maltodextrin, lactic esters of fatty acids mono- and diglycerides, methylcellulose, guar gum, carrageenan, sodium phosphate and salt.

The friction coefficient as a function of sliding velocity of the above-mentioned commercial compositions and of an oleosome composition according to the invention having a total solids content of 20% (designated as “Cultivated Cream 20%”) was measured as described in Example 6. The results are provided in [FIG. 5].

In the area corresponding to the boundary regime, the composition of the present invention exhibits the lowest friction coefficient as a function of sliding velocity and in particular at a sliding velocity, of 0.1 m/s, which best mimics the conditions occurring in the oral cavity upon consumption of a food product such as cream. Only at higher sliding velocity does the friction coefficient of the composition of the invention increase significantly. However, such high velocities are of little relevance with respect to the behavior of the composition in the oral cavity. This demonstrates that the cream composition of the invention is characterized by a better mouthfeel than the commercial cream, despite the presence of texturizing agents in the commercial products. This is even more the case because the cream compositions of the invention also demonstrate high viscosity, as demonstrated in Examples 7 and 8.

### Example 10: Reduction of Astringency of Pea Protein

A dynamic tribological approach was used to measure the changes in the frictional coefficient of saliva upon the addition of a yeast oleosome composition according to the invention. All tribological measurements were performed with an Anton Paar Rheometer MCR302 (Austria). A tribology cell (BC12.7/SS 52837) was used to measure the lubrication properties of the samples in combination with saliva. Polydimethylsiloxane (PDMS) pins were used since PDMS is a prevailing material currently used in soft tribology. The friction was measured using a commercial (glass) ball on a three-PDMS pin setup. The glass ball had a diameter of 12.7 mm and PDMS pins a diameter of 6 mm and a height of 6 mm with a modulus of around 2 MPa. Glass ball and PDMS pins were obtained by the rheometer manufacturer.

The measurements were performed in triplicates. A normal force, Fn, of 1 N was applied. The experiments were carried out at a constant rotational speed of 1 mm/s to gain boundary regime friction profiles, as this regime is believed to be closely related to the perception of astringency in humans. The measurements were taken within a period of 10 minutes, where the first 5 minutes were used for the salivary proteins to cover the PDMS pins (ex-vivo salivary pellicle). The salivary layer allows the glass probe to slide against the PDMS pins while lubricating by 0.5 mL of saliva. When the 5 minutes passed and a constant friction coefficient was obtained, the model solution (MS) were each added in a 1:1 (saliva: MS) ratio.

An example of measurement (not related any of the present MS) is shown in [FIG. 7]. With the use of such graphs (data not shown), the difference in friction coefficient (Au) was calculated as Av.CoF₁−Av.CoF₂, where Av.CoF₁ is the friction coefficient obtained when salivary proteins fully covered the PDMS surface, and Av.CoF₂ is the friction coefficient after the addition of the MS. All the friction coefficients represent mean values by taking each average value based on five points.

Three different aqueous model solutions were prepared for the tribological measurement, as summarized in [Table 3] below, wherein parts are defined by weight, based on the total weight of the model solution. As a control, water was used.

TABLE 3

| | Amount | Amount | Amount |
|---|---|---|---|
| | in MS1 | in MS2 | in MS3 |
| | [parts] | [parts] | [parts] |
| 5% Pea protein | 1 | 0.5 | 0 |
| solution in water | | | |
| Yeast oleosome | 0 | 0.5 | 1 |
| composition | | | |
| (“Cultivated | | | |
| extract”) | | | |

The selected astringent agent was pea protein isolate (PPI; origin KoRo Handels GmbH, Koppenplatz 9, 10115 Berlin), which commonly gives a dry oral sensation. The 5% pea protein solution had a composition of 5 wt % PPI and 95 wt % water and was prepared as follows. To fully solubilize the PPI in water, the solution was stirred at a temperature of 43° C. for 30 minutes. Following this, the solution was cooled to 4° C.

The yeast oleosome composition (referred to as “Cultivated extract”) was as disclosed in [Table 4].

TABLE 4
Part I

| Particle size¹ | Density | Zeta potential | |
|---|---|---|---|
| μm | g/L | mV | pH |
| 0.2 | 0.98 | −20 | 6.6 |

¹Mean diameter, as measured by dynamic light scattering using a Zetasizer Ultra (Malvern Instruments)

TABLE 4
Part II

| Total | Fat | Protein | Carbohydrate |
|---|---|---|---|
| solids | content | content | content |
| wt %² | wt %² | wt %² | wt %² |
| 12.7 | 1.5 | 5.5 | 5 |

²based on the total weight of the composition.

For preparing MS2, the 5% pea protein solution described above was combined with Cultivated extract in a 1:1 ratio, effectively creating a new solution with equal parts of the yeast oleosome composition and the pea protein solution.

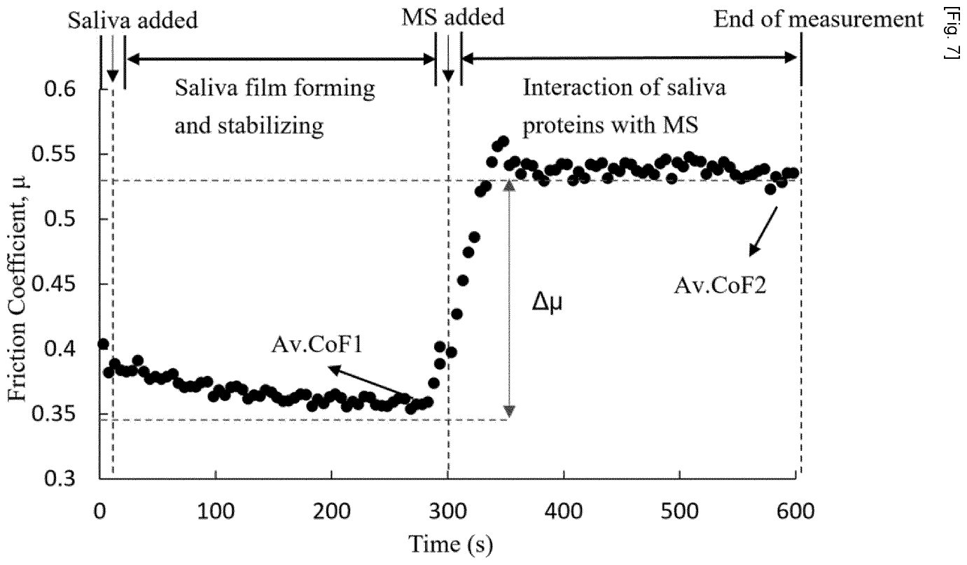

The results are provided in [FIG. 6]. A decrease in salivary lubrication was observed with MS2 comprising pea protein alone. In contrast, with MS3, the yeast oleosome composition was able to completely mask the heightened friction induced by the pea protein, effectively creating a smoother texture. The friction observed with MS3 was even lower than that of the control having no pea protein.

### Example 11: Sensory Evaluation of Astringency Reduction

The objective of this assessment was to evaluate the sensory properties of different dairy-analogue formulations and determine their astringency masking properties. The tested samples were as described in [Table 5].

TABLE 5

| | Sample | Sample |
|---|---|---|
| Ingredient | CBA14 | PPI solution |
| Water | 0 | 95 |
| Cultivated Extract (as used | 95 | 0 |
| in Example 10) | | |
| Pea protein isolate¹ | 5 | 5 |

¹Origin KoRo Handels GmbH, Koppenplatz 9, 10115 Berlin

The samples were prepared by dissolving the pea protein isolate either in water or in Cultivated Extract. To fully solubilize the PPI in water, the solution was stirred at a temperature of 43° C. for 30 minutes. Following this, the solution was cooled to 4° C.

A panel of 10-15 panelists was recruited. Panelists had no known allergies or intolerances to the dairy-analogue formulations being tested. They also did not suffer from colds or other sensory impairments during the evaluation. The panelists did not consume food or smoke an hour before the tasting.

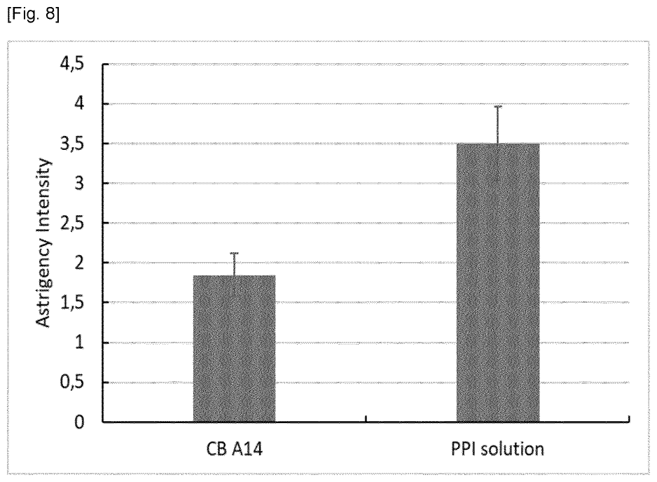

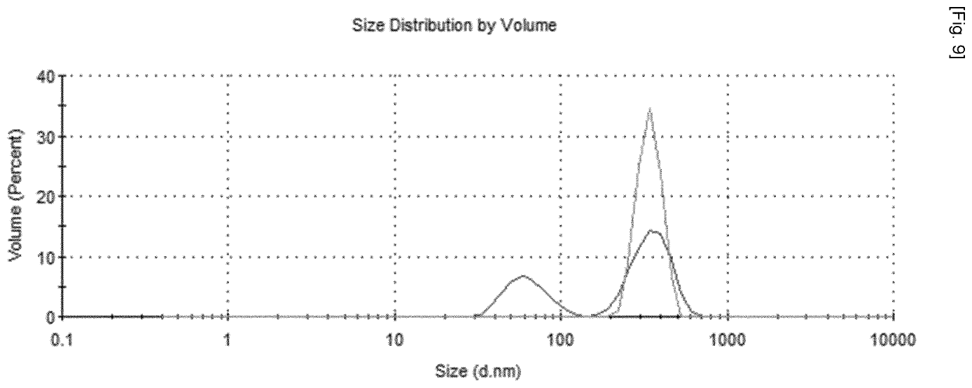

All samples were maintained at approximately 10° C. and were presented in identical containers (20 g), labeled with randomized three-digit codes to ensure anonymity. The samples were weighed in advance (around 10 ml). Panelists were given a standardized evaluation form to rate the samples based on specific sensory attributes. Sensory attributes to be evaluated included astringency. Each attribute was rated on a scale of 1-5, with 1 being the lowest and 5 being the highest score. The results were as provided in [FIG. 8]. The sample comprising the yeast oleosome composition of the invention (CB A14) was found significantly less astringent than the sample without the yeast oleosome composition of the invention (PPI solution).

### Example 12: Ice Cream Compositions

Ice cream compositions were prepared having the ingredients provided in [Table 6] below.

Ice creams were prepared by mixing all the ingredients in the termomix, temperature of 80° C. was kept for 10 mins, resulting solutions were homogenised for 2 mins with the termomix at highest speed. The solutions were stored in the fridge overnight and ice cream was prepared the following morning.

TABLE 6

| | Ice Cream A | Ice Cream B | Ice Cream C | Ice Cream D |
|---|---|---|---|---|
| | [% w/w] | [% w/w] | [% w/w] | [% w/w] |
| Oleosome | 67 | 33.5 | 80 | 67 |
| cream¹⁾ | | | | |
| Sugar | 20 | 20 | 20 | 20 |
| Water | 11 | 41.5 | — | 11 |
| Flavour | 0.02 | — | — | |
| Coconut fat | — | 5 | — | |
| Locust been | — | — | — | 0.02 |
| Gum | | | | |

¹⁾With a fat content of 13 wt %, fiber content of 3.5 wt % and protein content of 4.5 wt %.

### Example 13: Comparison of Product Properties Associated with Extraction Method

A comparative study was conducted to investigate the impact of particular steps of the extraction method on product properties. Two samples of oleosome compositions were prepared from the same biomass. One sample was prepared using the process of Example 4 (invention), and the second sample was produced using a process such as used in Han et al., Tunable nano-oleosomes derived from engineered Yarrowia lipolytica, Biotechnology and Bioengineering, 110 (3), 702-710, i.e a process involving
a) Washing the biomass with PBS buffer,
b) Cell lysis with glass beads and vortex mixer (bead milling),
c) and centrifugation.

The properties of both samples were analyzed as follows.

Total solids content of the samples was determined gravimetrically by difference between fresh weight and weight after complete freeze-drying.

Fat quantitation of the samples was conducted by modified Folch gravimetric assay. Briefly, hydrophobic compounds were extracted from aliquots of 300 mg of freeze dried material with a mixture of methanol and tert-butyl ether, then water was added. Fats remained in the organic fraction, which was collected, dried and weighed. Analysis was performed in duplicate.

Protein content was measured by total combustion with a CHNS elemental analyzer (Vario EL Cube, Elementar Analysensysteme GmbH). Briefly, aliquots of 3 mg of freeze dried material were loaded into tin boats and incinerated in the furnace of the analyzer. Combustion gases were eluted on its chromatographic column and the nitrogen gas quantified by the associated thermal conductivity detector. Protein content was then obtained by multiplying the nitrogen content by the conventional conversion factor of 6.25. Analysis was performed in duplicate.

Protein content was measured by total combustion with a CHNS elemental analyzer (Vario EL Cube, Elementar Analysensysteme GmbH). Briefly, aliquots of 3 mg of freeze dried material were loaded into tin boats and incinerated in the furnace of the analyzer. Combustion gases were eluted on its chromatographic column and the nitrogen gas quantified by the associated thermal conductivity detector. Protein content was then obtained by multiplying the nitrogen content by the conventional conversion factor of 6.25. Analysis was performed in duplicate.

The individual droplet size of yeast extracted oleosome was measured with dynamic light scattering (Malvern Instruments Zetasizer, UK). The droplet size was represented by the volume and number mean diameter. The samples were measured with the use of a refractive index of 1.47. After the determination of particle size, a maximum of 40 mV was applied to measure the zeta potential in folded capillary zeta cells (DTS1070, Marvern, UK).

The results are provided in [Table 7] below.

TABLE 7
Part I

| | Particle size | Zeta potential | |
|---|---|---|---|
| Sample | μm | mV | pH |
| Han et al. | 0.08-0.01 | −14.1 | 6.7-7 |
| Invention | 0.6-0.8 | −28.4 | 6.7-7 |

TABLE 7
Part II

| | Total | Fat | Protein | Beta-glucan |
|---|---|---|---|---|
| | solids | content | content | content |
| Sample | wt %² | wt %² | wt %² | wt % |
| Han et al. | 1.37 | <0.1 | 0.75 | 0.01 |
| Invention | 16.6 | 9.2 | 0.66 | 1.00 |

The method described in Han et al. resulted in a very liquid composition with only little solids content, essentially no fat and essentially no beta-glucans, further exhibiting a very small particle size suggesting that the oleosomes structure was not retained. In contrast, the composition obtained according to the invention has much higher fat and solid contents (resulting in an advantageous thicker and more viscous texture), a larger particle size and a non-negligible amount of free beta-glucan, released from the cell wall structure. These differences are due to the fact that bead milling breaks the structure of the oleosomes and is not able to lyse the cell walls and is not able to extract the yeast cell wall component beta glucan from the structure of the yeast cell wall, in contrast to high-pressure homogenization used in the present invention.

The process characteristics were as provided in [Table 8] below:

TABLE 8

| | | Yield | Yield |
|---|---|---|---|
| | Cell | based on | based on |
| | lysis | total solids | fat content |
| Sample | (%) | (%) | (%) |
| Han et al. | 10-20% | 10 | ~0 (recovered |
| | | | fat below |
| | | | detection limit) |
| Invention | 75-85% | 38 | 48 |

These results demonstrate that the process of the invention (involving high-pressure homogenization instead of bead milling) achieves a much better yield in terms of total solids and fat content and breaks the walls much more efficiently, thus releasing the beta-glucans from the yeast cell walls structure.

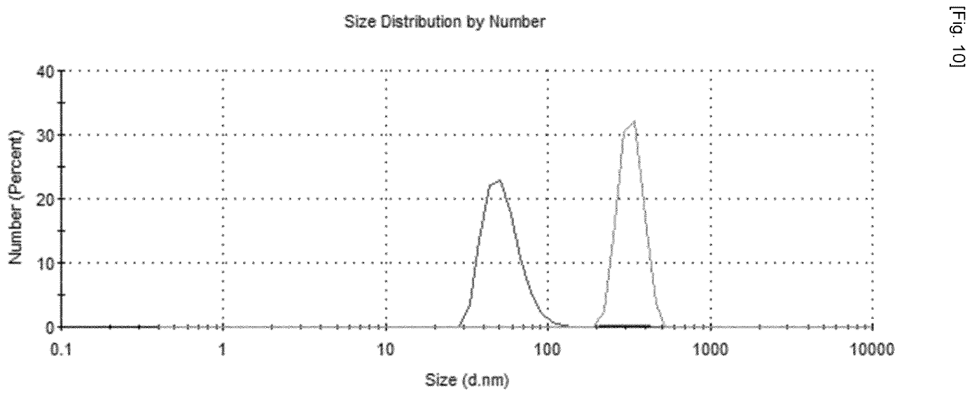

The particle size of both samples is further shown in [FIG. 9] and [FIG. 10]. The average diameter of droplet size based on number distribution and zeta potential are clearly different between the product obtained by the process of Han et al. and that obtained by the process of the present invention.

Microscopy images of both samples are provided in [FIG. 11]. The images on the right, corresponding to sample of the invention, show many more intact oleosome structures compared to the images on the left corresponding to Han et al. This confirms the conclusions drawn above from the analytical results.

The picture in [FIG. 12] shows both samples after centrifugation. For each sample the solid phase is identified by the dashed line black triangle and the light phase (cream phase) comprising the oleosomes is identified by the black solid line triangle. The composition obtained by the method of Han et al. has a much larger solid phase and a tiny cream phase, whereas the process of the invention provides a large cream phase and a smaller solid phase. This picture demonstrates a better oleosome and fat content extraction achieved with the process of the invention.

In conclusion, it has been shown that the products obtained by the process of Han et al. and those of the present invention have significantly different chemical compositions. Samples extracted with the process of the invention have different amounts of solids, fat, protein and glucans. The method of Han et al. leads to low amounts of oleosomes that cannot be retrieved by the separation step, and polysaccharides from cell walls have been shown not to be debranched, leading to negligible amounts of beta-glucans extracted from the yeast cell wall (isolated beta-glucan). In contrast, the composition obtained with the process of the invention leads to large amounts of intact oleosomes together with isolated soluble fibres such as beta-glucan, and a high fat content of 60-80% by weight, based on the total dry weight of the composition.

1. A yeast oleosome composition comprising yeast oleosomes and at least one isolated yeast cell wall component selected from chitin, β-D-glucan, and mannoprotein.

2. The yeast oleosome composition according to claim 1, having a particle size characterized by a mean diameter by volume of 0.2 to 7 μm, as measured by dynamic light scattering.

3. The yeast oleosome composition according to claim 1, wherein the composition has a density of 0.8 to 1.1 g/ml.

4. The yeast oleosome composition according to claim 1, wherein the zeta potential at the surface of the oleosomes in the composition is −40 to −20 mV and/or wherein the pH of the yeast oleosome composition is of 5 to 8.

5. The yeast oleosome composition according to claim 1, wherein the yeast is an oleaginous yeast selected from the genera Yarrowia, Candida, Rhodotorula, Rhodosporidium, Cryptococcus, Trichosporon, Cutaneotrichosporon, Lipomyces, Papiliotrema, Hannaella, Sporidiobolus, Kodamaea, Pichia, Saitozyma, Cyberlindnera, Meyerozyma, Piskurozyma, and a mixtures thereof.

6. The yeast oleosome composition according to claim 1, wherein the composition is a milk alternative composition having a particle size characterized by a mean diameter by volume of 0.2 to 2 μm, a density of 0.8 to 1.1 g/mL, a total solids content of 2 to 10 wt %, a fat content of 1.25 to 4 wt %, a carbohydrate content of up to 3%, and a protein content of 0.1 to 1.5 wt %, based on the total weight of the composition.

7. The yeast oleosome composition according to claim 1, wherein the composition is a cream alternative composition having a particle size characterized by a mean diameter by volume of 0.4 to 7 μm, a density of 0.85 to 1.2 g/mL, a total solids content of 30 to 45 wt %, a fat content of 17 to 38 wt %, a carbohydrate content of 0.5 to 15 wt %, and a protein content of 2.5 to 7 wt %, based on the total weight of the composition.

8. The yeast oleosome composition according to claim 1, wherein the composition is characterized by a friction coefficient in the boundary regime of 0.01 to 0.5.

9. A process of the preparation of a yeast oleosome composition comprising the steps of:
a) providing washed yeast cells;
b) lysing the cell wall; and
c) separating the oleosomes from other yeast cell components;
wherein step b) comprises:
i. alkaline treatment;
ii. contacting the yeast cells with an organic solvent;
iii. autolysis;
iv. enzymatic treatment applied to a washed biomass and suspended at a concentration of 50 to 200 g/L in water or a suitable pH buffer with an incubation temperature of 30 to 50° C. and an incubation time of 0.5 to 8 hours to allow degradation of cell wall biopolymers;
v. high pressure homogenization; or
vi. a mixture thereof.

10. A process according to claim 9, wherein step b) comprises:
alkaline treatment followed by high pressure homogenization;
autolysis comprising heating the yeast cells to a temperature of 50° C. or more, reducing stirring and stopping aeration until spontaneous lysis of the yeast cells occurs; and
enzymatic treatment applied to a washed biomass and suspended at a concentration of 50 to 200 g/L in water or a suitable pH buffer with an incubation temperature of 30 to 50° C. and an incubation time of 0.5 to 8 hours to allow degradation of cell wall biopolymers, followed by high pressure homogenization.

11. A process according to claim 9, wherein step c) comprises decantation, centrifugation, filtration, or flocculation.

12. A yeast oleosome composition obtainable or obtained by the process according to claim 9.

13. A yeast oleosome composition in solid form obtained or obtainable by drying the yeast oleosome composition according to claim 1.

14. A product comprising a yeast oleosome composition according to claim 1.

15. The product according to claim 14, wherein the product is a food product, a beverage, or a cosmetic product.

16. A method for improving sensory properties of a food product, a beverage, or an edible ingredient, the method comprising adding the yeast oleosome of claim 1 or a composition comprising the yeast oleosome to the food product, the beverage, or the edible ingredient.

17. The method according to claim 16, wherein the intensity of astringency of a food product or beverage comprising at least one astringent component is reduced.

18. The method according to claim 17, wherein the perception of astringency by a subject upon consumption of a food product or beverage comprising at least one astringent component is reduced.

19. The method according to claim 16, wherein the food product or beverage comprises at least one astringent component.

20. The yeast oleosome composition according to claim 1, wherein the yeast is Yarrowia lipolytica.
